(19) United States
(12) Patent Application Publication
(10) Pub. No.: US 2024/0218657 A1
(43) Pub. Date: Jul. 4, 2024

(54) FIRESTOP FLUTE PLUG

(71) Applicant: CEMCO, LLC, City of Industry, CA (US)

(72) Inventor: Donald Anthony Pilz, Livermore, CA (US)

(21) Appl. No.: 18/608,739

(22) Filed: Mar. 18, 2024

Related U.S. Application Data
(63) Continuation-in-part of application No. 17/453,158, filed on Nov. 1, 2021, now Pat. No. 11,933,042.
Application No. 17/453,158 is a continuation of application No. 16/398,144, filed on Apr. 29, 2019, now Pat. No. 11,162,259.
(60) Provisional application No. 62/664,832, filed on Apr. 30, 2018.

(51) Int. Cl. E04B 1/94; A62C 2/06

(52) U.S. Cl. CPC E04B 1/948; A62C 2/06; E04B 1/941

(57) ABSTRACT

An improved flute plug for a head-of-wall assembly for fire rated wall construction beneath a fluted deck or ceiling. The improved flute plug can be friction fit within individual flute voids that run over the top of the header track. The improved flute plug can include a single piece pre-bent steel profile with fire stopping material attached thereto or contained therein. The fire stopping material can be oversized so that it will compress into the flute void over the top of the header track. The compressed fire stopping material can provide a seal against fire, smoke and/or noise through the fluted deck voids.

### RELATED APPLICATION

This application is a continuation-in-part of U.S. patent application Ser. No. 17/453,158, filed Nov. 1, 2021, pending, which is a continuation of U.S. patent application Ser. No. 16/398,144, filed Apr. 29, 2019, now U.S. Pat. No. 11,162,259, which claims the benefit of U.S. Provisional Patent Application No. 62/664,832, filed Apr. 30, 2018, the entireties of which are hereby incorporated by reference.

### BACKGROUND

### Field

The present disclosure relates to fire-resistant arrangements for building structures. In particular, disclosed arrangements are wall gap fire resistant structures or “fire blocks” that reduce or prevent fire, air, smoke and heat from passing from one side of a wall to the other side through a wall gap.

### Related Art

To meet relevant building codes and standards (e.g., UL-2079), a fire block for a head-of-wall assembly must pass both an air leakage test and a hose stream test. A conventional fire block involves a mineral wool or other fire block material positioned within the gaps in the head-of-wall assembly. Once the gaps are filled with the fire block material, a flexible coating, such as an elastomeric coating, can be sprayed on head-of-wall to secure the fire block material in place. This arrangement requires a significant amount of time and expertise to install. In addition, over a period of time, the flexible coating may degrade, resulting in cracks and/or flaking. As a result, it is possible that the fire resistant material may become dislodged from the head-of-wall gaps thereby reducing or eliminating the effectiveness of the fire block.

### SUMMARY

An aspect of the present disclosure involves a flute plug assembly or a wall incorporating a flute plug assembly, wherein the flute plug assembly is configured for installation in a single flute of an overhead structure. The flute plug assembly includes a support and a fire-blocking material plug. The support includes an attachment portion and at least one retention portion. The attachment portion is configured to be coupled to a header track and the retention portion is configured to block removal of the fire-blocking material plug from the flute.

In some configurations, at least the support and the fire-blocking material plug of the flute plug assembly are pre-assembled and inserted into the flute as a unit.

In some configurations, the at least one retention portion comprises a first retention portion and a second retention portion positioned on opposing sides of the fire-blocking material plug. In some such configurations, at least one retention portion is unitarily-formed with the attachment portion. In some configurations, the retention portion is constructed in whole or in part from a metal, gypsum board or plastic material.

In some configurations, the flute plug assembly extends only a portion of a length of a fluid void. In some such configurations, a pair of flute plug assemblies are positioned on opposite sides of the wall assembly in opposing ends of the flute void.

In some configurations, a maximum length of the flute plugs is less than the sum of a maximum width of the flute and a distance between flutes. In some such configurations, a maximum length of the flute plug assembly is substantially equal to a maximum width of the flute.

In another aspect, a head-of-wall assembly includes a fluted pan deck including a plurality of flutes aligned along a first direction. A flute of the plurality of flutes defines a concave perimeter and a flute void. A header track couples to the fluted pan deck is aligned along a second direction. The second direction is transverse to the first direction. The header track includes a first leg, a second leg and a web coupling the first and second legs. A plurality of studs couple the header track between the first and second legs. At least one wallboard couples to the plurality of studs. A deflection gap extends across the head-of-wall assembly. A flute plug assembly includes a profile. The profile includes a lower flange. The lower flange couples to a first intermediate flange. The first intermediate flange couples to a front upper flange having a first outer profile. The lower flange couples to a second intermediate flange. The second intermediate flange couples to a rear upper flange having a second outer profile. A fire blocking material has a third outer profile. The fire blocking material is within a slot between the front and rear upper flanges. The flute plug assembly is aligned with the flute void and the lower flange is couples to the header track by a first fastener. The fire blocking material compresses against the concave perimeter of the flute void to seal the head-of-wall assembly against fire, smoke and sound through the flute void.

In another aspect, a head-of-wall assembly includes a fluted pan deck including a plurality of flutes aligned along a first direction. A flute of the plurality of flutes defining a concave perimeter and a flute void. A header track couples to the fluted plan deck. The header track includes a first leg, a second leg, and a web coupling between the first and second legs. A plurality of studs couple within the header track. At least one wallboard couples to the plurality of studs. A flute plug assembly includes a profile. The profile includes a lower flange, an intermediate flange, and an upper flange having a first outer profile. A fire blocking material has a second outer profile. The flute plug assembly is aligned with the flute void and the lower flange is couples to the header track. The fire blocking material contacts the concave perimeter of the flute to seal the flute void against fire, smoke, and sound.

In another aspect, a flute plug assembly for installation within a head-of-wall assembly includes a metal profile. The metal profile includes a lower flange aligned generally vertically. A first intermediate flange aligns generally horizontally. The first intermediate flange couples on a first end with the lower flange. A front upper flange aligns generally vertically and has a first outer profile. The front upper flange couples to a second end of the first intermediate flange. A second intermediate flange aligns generally horizontally and opposite the first intermediate flange. The second intermediate flange couples on a first end with the lower flange. A rear upper flange aligns generally vertically and has a second outer profile. The rear upper flange couples to a second end of the second intermediate flange. A fire blocking material has a third outer profile. The fire blocking material is a slot between the front and rear upper flanges. The flute plug assembly is aligned within a flute void of a fluted ceiling and the fire blocking material compressed against a concave perimeter of the flute void to seal the head-of-wall assembly against fire, smoke and sound through the flute void.

In another aspect, a head-of-wall assembly includes a fluted pan deck including a plurality of flutes aligned along a first direction. A flute of the plurality of flutes defines a concave perimeter and a flute void. A header track couples to the fluted plan deck and aligned along a second direction. The second direction is transverse to the first direction. The header track includes a first leg, a second leg, and a web coupling between the first and second legs. A plurality of studs couple within the header track. At least one wallboard couples to the plurality of studs. A flute plug assembly includes a profile. The profile includes a lower flange. An upper flange has a first outer profile. An intermediate flange couples the lower flange and the upper flange. An fire blocking material has a second outer profile. A first fastener couples the fire blocking material with the upper flange. The flute plug assembly is aligned with the flute and the lower flange couples to the header track by a second fastener. The second outer profile of the fire blocking material contacts the concave perimeter of the flute to seal the flute void against fire, smoke, and sound.

In some embodiments, the techniques described herein relate to a head-of-wall assembly. The head-of-wall assembly can include a fluted pan deck including a plurality of flutes aligned along a first direction. In some embodiments, a flute of the plurality of flutes can define a concave perimeter, and a flute void. In some embodiments, the head-of-wall assembly can include a header track coupled to the fluted pan deck and aligned along a second direction. In some embodiments, a second direction can be transverse to the first direction. The header track can include a first vertical leg, a second vertical leg, and a web coupling the first vertical leg and the second vertical leg. In some embodiments, the head-of-wall assembly can include a plurality of studs secured within the header track between the first vertical leg and the second vertical leg. In some embodiments, the head-of-wall assembly can include at least one wallboard coupled to the plurality of studs; and a deflection gap across the head-of-wall assembly. In some embodiments, the head-of-wall assembly can include a first flute plug assembly including a profile. The profile can include a vertical lower flange. The vertical lower flange can be coupled to an intermediate flange. The intermediate flange can be coupled to an upper flange having a first outer profile. In some embodiments, a fire blocking material can have a second outer profile. In some embodiments, a double-sided tape strip can extend lengthwise along the vertical lower flange. In some embodiments, the first flute plug assembly can be aligned with the flute void. In some embodiments, the vertical lower flange can be coupled to the first vertical leg of the header track by the double-sided tape strip. In some embodiments, the fire blocking material compresses against the concave perimeter of the flute void to seal the head-of-wall assembly against fire, smoke and sound through the flute void. In some embodiments, the upper flange can assist in retaining the fire blocking material within the flute void.

In some embodiments, the techniques described herein relate to a head-of-wall assembly, wherein the profile can be a sheet of bent steel.

In some embodiments, the techniques described herein relate to a head-of-wall assembly, wherein the first outer profile can match the concave perimeter of the flute void.

In some embodiments, the techniques described herein relate to a head-of-wall assembly, wherein the first outer profile can offset from the concave perimeter of the flute void at a spacing distance, the spacing distance being between 0.25 inches and 0.75 inches.

In some embodiments, the techniques described herein relate to a head-of-wall assembly, wherein the spacing distance can be uniform across the first outer profile.

In some embodiments, the techniques described herein relate to a head-of-wall assembly, wherein the upper flange can be biased inwardly to compress the fire blocking material.

In some embodiments, the techniques described herein relate to a head-of-wall assembly, wherein the intermediate flange can be aligned with a lowermost portion of the fluted pan deck to provide an upper surface of the deflection gap across the flute void.

In some embodiments, the techniques described herein relate to a head-of-wall assembly, wherein the intermediate flange can be aligned with the web of the header track and the vertical lower flange overlaps the first vertical leg of the header track.

In some embodiments, the techniques described herein relate to a head-of-wall assembly wherein the concave perimeter and the first outer profile each can include a top and first and second lateral sides.

In some embodiments, the techniques described herein relate to a head-of-wall assembly. In some embodiments, the head-of-wall assembly can further include a second flute plug assembly. The second flute plug assembly can include a profile. The profile can include a vertical lower flange. The vertical lower flange can be coupled to an intermediate flange. The intermediate flange can be coupled to an upper flange. The upper flange can have a first outer profile. The second flute plug assembly can further include a fire blocking material. In some embodiments, the first flute plug assembly can be assembled on a first side of the flute void and the second flute plug assembly can be assembled on a second side of the flute void, the second side being opposite to the first side.

In some embodiments, the techniques described herein relate to a head-of-wall assembly that can further include a second flute plug assembly. In some embodiments, the first flute plug assembly can be assembled on a first side of the flute void and the second flute plug assembly can be assembled on a second side of the flute void where the second side is opposite the first side.

In some embodiments, the techniques described herein relate to a head-of-wall assembly. In some embodiments, the head-of-wall assembly can include a fluted pan deck that can include a plurality of flutes aligned along a first direction. In some embodiments, a flute of the plurality of flutes can define a concave perimeter and a flute void. In some embodiments, the head-of-wall assembly can include a header track coupled to the fluted pan deck. The header track can be aligned along a second direction where the second direction can be transverse to the first direction. The header track can include a first vertical leg, a second vertical leg, and a web extending between the first vertical leg and the second vertical leg. The web can couple the first vertical leg and the second vertical leg. The head-of-wall assembly can include a plurality of studs positioned within and coupled to the header track. The head-of-wall assembly can include at least one wallboard coupled to the plurality of studs. In some embodiments, the head-of-wall assembly can include a flute plug assembly. The flute plug assembly can include a pair of profiles each positioned on opposing sides of the header track. The pair of profiles can each include a vertical lower flange, an intermediate flange, and a vertical upper flange. The vertical upper flanges can each have a first outer profile. In some embodiments, the flute plug assembly can further include a fire blocking material. The fire blocking material can have a second outer profile positioned between the vertical upper flanges. In some embodiments, the flute plug assembly can be coupled to the header track and aligned with the flute void such that the fire blocking material is disposed within the flute void. In some embodiments, the vertical lower flanges are aligned along and coupled to the first vertical leg and the second vertical leg of the header track with the double-sided tape. In some embodiments, the fire blocking material can contact the concave perimeter of the flute to seal the flute void against fire, smoke, and sound.

In some embodiments, the techniques described herein relate to a head-of-wall assembly, wherein the fire blocking material can be compressible, and the vertical upper flanges can compress the fire blocking material against the concave perimeter.

In some embodiments, the techniques described herein relate to a head-of-wall assembly, wherein the second outer profile of the fire blocking material can be larger in at least one direction than the concave perimeter of the flute void.

In some embodiments, the techniques described herein relate to a head-of-wall assembly, wherein the pair of profiles can include a sheet of bent steel.

In some embodiments, the techniques described herein relate to a head-of-wall assembly, wherein the first outer profile can offset from the concave perimeter of the flute void at a spacing distance, the spacing distance being between 0.25 inches and 0.75 inches.

In some embodiments, the techniques described herein relate to a head-of-wall assembly, wherein the spacing distance can be uniform across the first outer profile.

In some embodiments, the techniques described herein relate to a head-of-wall assembly, wherein the intermediate flanges can be aligned with a lowermost portion of the fluted pan deck to provide an upper surface of a deflection gap across the flute void.

In some embodiments, the techniques described herein relate to a head-of-wall assembly, wherein the fire blocking material can overlap the web of the header track and the vertical lower flanges can overlap a respective first leg or second leg of the header track.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 is an elevation view of a head-of-wall assembly having a flute plug assembly positioned within a head-of-wall gap.

FIG. 2 is a front view of the flute plug assembly of FIG. 1.

FIG. 3 is a section view of the flute plug assembly taken along the line 3-3 in FIG. 2.

FIG. 4 is an orthogonal section view of the head-of-wall assembly of FIG. 1.

FIG. 5 is an elevation view of a head-of-wall assembly showing three flute plug assemblies.

FIG. 6 is a section view of another embodiment of a flute plug assembly.

FIG. 7 is an orthogonal section view of a head-of-wall assembly incorporating the flute plug assembly of FIG. 6 on each side of the wall.

FIG. 8 is a section view of another embodiment of a flute plug assembly.

FIG. 9 is a section view of another embodiment of a flute plug assembly.

FIG. 10 shows the section assembly of FIG. 8 with an expandable fire blocking material in an expanded state.

FIG. 11 is a section view of another embodiment of a flute plug assembly.

FIG. 12 is a section view of a profile portion of another embodiment of a flute plug assembly.

FIG. 13 is a section view of a profile portion of another embodiment of a flute plug assembly.

FIG. 14 is a section view of a head-of-wall assembly incorporating a flute plug assembly having the profile portion of FIG. 12 on each side of the wall.

FIG. 15 is a section view of another head-of-wall assembly incorporating a flute plug assembly having the profile portion of FIG. 12 on each side of the wall.

FIG. 16 is a section view of another head-of-wall assembly incorporating a flute plug assembly having the profile portion of FIG. 13 on each side of the wall.

### DETAILED DESCRIPTION

The various features and advantages of the technology described herein will become more fully apparent from the following description of the embodiments illustrated in the figures. These embodiments are intended to illustrate the principles of this disclosure, and this disclosure should not be limited to merely the illustrated examples. The features of the illustrated embodiments can be modified, combined, removed, and/or substituted as will be apparent to those of ordinary skill in the art upon consideration of the principles disclosed herein.

A head-of-wall assembly can be an interface between an upper end of a wall (e.g., an interior wall) and an overhead or horizontal support structure (e.g., a ceiling structure—which may form a floor structure of an adjacent upper floor of the building). A head-of-wall assembly can include a gap that enables relative movement between the ceiling and the upper end of the wall. As described above, the head-of-wall assembly must be fire blocked or sealed against the passage of fire, smoke and/or noise from one side of the wall to the other side. Accordingly various technologies have been developed to provide such a seal that also allow for dynamic movement of the head-of-wall assembly. As one example, the assignee of the present application has developed advanced head-of-wall fire block arrangements sold under the trademark FAS TRACK® and described in U.S. Pat. Nos. 10,184,246 and 10,214,901, among other patents.

In some head-of-wall assemblies, the ceiling is made from a corrugated or fluted pan deck. The fluted pan deck can include a plurality of parallel flutes aligned along one direction. In some cases, an interior wall can extend across the flutes, leaving a flute void in the head-of-wall assembly that must also be sealed. As noted above, the conventional methodology is to fill these flute voids with a compressed mineral fiber and to apply a fire sealant material over the outside of the head-of-wall assembly. This process can be time consuming and may deteriorate over time.

U.S. Pat. No. 6,058,668 to Herren describes an alternative solution to the traditional stuff and seal methodology. In Herren, an angle piece is positioned on each side of a header track of the wall assembly. The angle piece includes a steel tab that can be folded up and positioned within the flute voids. The tabs of the opposing angle pieces cooperate to secure the mineral wool within the flute voids. However, the solution in Herren cannot be used in conjunction with many advanced head-of-wall fire block arrangements. In many advanced head-of-wall fire block arrangements, there must be two surfaces facing each other along which the fire stopping material can be applied. In a typical head-of-wall assembly, one surface can be a top of a wallboard and the second surface can be mineral wool or another material in the head-of-wall assembly that faces the top of the wallboard. However, in the Herren design, the tabs block or fail to provide the second surface to which fire stopping material can be applied. Thus, the Herren design does not provide an adequate seal to prevent fire, smoke and sound without the application of a conventional spray sealant. Accordingly a need exists for an economical and effective head-of-wall assembly including flute voids.

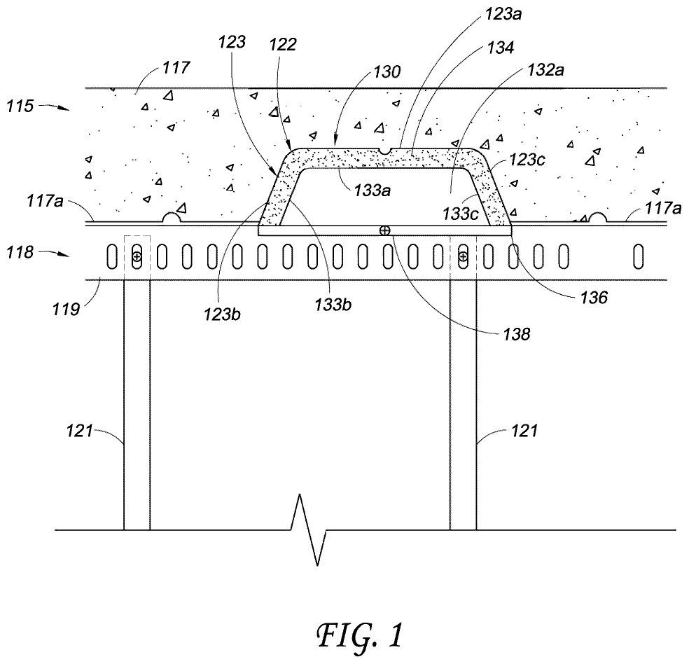

FIG. 1 shows a head-of-wall assembly 115. The head-of-wall assembly 115 can be an interface between an exterior, interior or other type of wall and an overhead structure or ceiling 117. In some implementations, the ceiling 117 can be generally horizontal respect to a ground surface. In one implementation, the ceiling 117 is a corrugated or fluted pan deck.

The fluted pan deck can be filled with concrete on an upper side thereof. The corrugations of the pan deck can define a plurality of flutes extending along the ceiling 117. The flutes can extend in the first direction. Each of the flutes can be spaced apart at regular intervals.

The flutes can be separated from each other by a plurality of corresponding lowermost portions 117a of the ceiling 117. The lowermost portions 117a can comprise planar surfaces. The planar surfaces can be generally horizontal. The lowermost portions 117a can be parallel with each other and extend in the first direction.

The head-of-wall assembly 115 can include a header track 118. The header track 118 can be coupled to the ceiling 117. The header track 118 can be coupled to the ceiling 117 by one or more mechanical fasteners, adhesives or other suitable connectors. In one implementation, the header track 118 is coupled to the lowermost portions 117a.

The head-of-wall assembly 115 can comprise a plurality of studs 121. The plurality of studs 121 can be coupled to the header track 118. The header track 118 can include a plurality of slots. Each of the studs 121 can connect to the header track 118 through one of the plurality of slots. The slots can enable the studs 121 to move in a linear direction with respect to the header track 118. The linear movement can accommodate movement between the ceiling 117 and the studs 121. The head-of-wall assembly 115 can further include one or more wallboards (not shown) attached with the plurality of studs 121 (not shown) on one or both sides of the wall. As is known it the art, the wall can include a footer track supported by a lower horizontal support structure (e.g., a floor) and lower ends of the studs 121 can be coupled to the footer track.

The head-of-wall assembly 115, including the header track 118, can be angled or aligned with respect to the plurality of flutes depending on a layout of the walls relative to the pan deck. In some cases, the header track 118 can be aligned in a second direction. The second direction can be at an angle between 0° and 180° with respect to the first direction. With the header track 118 aligned transverse to the plurality of flutes, the head-of-wall assembly 118 can include or define a plurality of voids corresponding to the plurality of flutes. To fire block or seal across the head-of-wall assembly, the flute voids can be filled or otherwise sealed, as described below.

The ceiling 117 includes a representative flute void 122. The flute void 122 is defined by a concave perimeter 123. The concave perimeter 123 need not be uniformly concave in all implementations. The concave perimeter 123 can be a generally, upwardly arced profile extending along the flute void 122. The flute void 122 can be located between two lowermost portions 117a of the ceiling 117. The concave perimeter 123 can include an upper side 123a. The concave perimeter 123 can include first and/or second sides 123b, 123c. The upper side 123a can be generally planar and/or horizontal. The first and/or second sides 123b, 123c can be angled with respect to the upper side 123a. The first and second sides 123b, 123c can connect between the lowermost portion 117a of the ceiling 117 and with the upper side 123a.

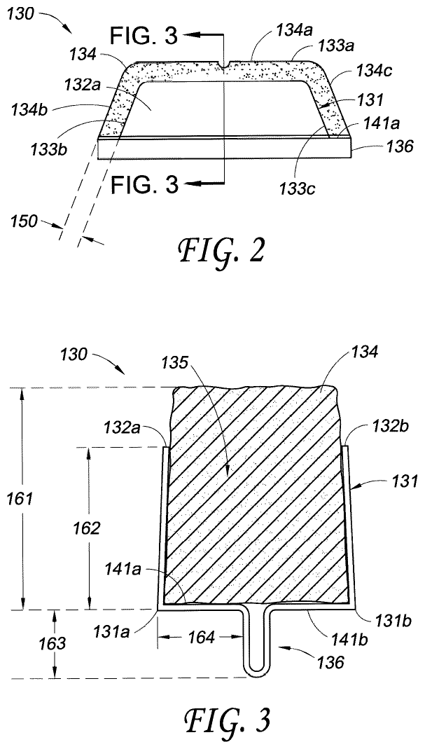

The head-of-wall assembly 115 can include a flute plug assembly 130. The flute plug assembly 130 is shown, in one implementation, in FIGS. 2 and 3. The flute plug assembly 130 can include a support, such as a frame or profile 131. The profile 131 can be formed of sheet metal or other suitable material (e.g., plastic). The metal can be steel, aluminum, or another suitable metal. The profile 131 can include a plurality of portions. In one implementation, the portions can be flanges. Thus, the term “flange” herein can be replaced with the term “portion.” Any one or combination of the flanges can be generally planar. In some configurations, the profile 131 is a single, continuous sheet of metal bent or otherwise shaped into a desired form.

The profile 131 can include a front upper flange 132a. The front upper flange 132a can extend in a generally upright or vertical orientation. The front upper flange 132a can have an outer profile. An example of the outer profile is shown in FIG. 2. The front upper flange 132a can include a top 133a. The top 133a can be generally straight and/or include one or more cutouts portions. The front upper flange 132a can include a first side 133b and/or a second side 133c. The top 133a and/or the first and second sides 133b, 133c can form the outer profile of the front upper flange 132a. In one implementation, the outer profile can generally match the concave perimeter 123 of the flute void 122. The outer profile can be generally trapezoidal.

The profile 131 can include an intermediate portion or base, which can be in the form of a flange 141a. The intermediate flange 141a can couple with the front upper flange 132a. The front upper flange 132a can connect with the intermediate flange 141a at a bend 131a. The bend 131a can form an angle between the front upper flange 132a and the intermediate flange 141a. The angle of the bend 131a can be between 0 degrees and 180 degrees. In one implementation, the angle is approximately 90 degrees. In another implementation, the angle is between approximately 80 degrees and 100 degrees. The first intermediate flange 141a can be generally horizontal in an as-used orientation or when the flute plug assembly 130 is assembled in a head-of-wall assembly 115.

The profile 131 can include an attachment portion, which can be in the form of a lower flange 136. The lower flange 136 can connect with the intermediate flange 141a (e.g., at a bend). The lower flange 136 can extend transversely from the intermediate flange 141a. In one implementation, the lower flange 136 can be generally vertically (in an as-used orientation) or perpendicular with the intermediate flange 141a. In one implementation, the lower flange 136 can comprise a bent region of the profile 131. The material of the profile 131 can be folded back over itself to form a generally flat or planar portion. The lower flange 136 can be generally flat or planar portion. The lower flange 136 can be a doubled layer of the material of the profile 131. The lowest point of the lower flange 136 can be a bend of the profile 131.

The lower flange 136 can connect with a second intermediate flange 141b. The second intermediate flange 141b can be coupled to the lower flange 136 at a bend. The second intermediate flange 141b can be generally perpendicular with the lower flange 136. In the illustrated arrangement, the second intermediate flange 141b is aligned with the intermediate flange 141a. In an alternative arrangement, the second intermediate flange 141b can be offset (e.g., out of alignment) from the intermediate flange 141a. The second intermediate flange 141b can be generally horizontal.

The second intermediate flange 141b can couple with a rear upper flange 132b. The rear upper flange 132b can extend generally vertically in an as-used orientation or at an angle with respect to the second intermediate flange 141b. The rear upper flange 132b can connect with the second intermediate flange 141b at a bend 131b. The rear upper flange 132b can be at any suitable angle with respect to the intermediate flange 141b. The angle can be any of the angles disclosed above for the angle of the bend 131a. The rear upper flange 132b can have an outer profile. The outer profile can be similar or identical to the outer profile of the front upper flange 132a. The outer profile of the rear upper flange 132b can be sized and/or shaped to align with or be offset from the outer profile of the front upper flange 132a.

The profile 131 can form an interior space or slot 135. The slot 135 can be located between the front upper flange 132a and the rear upper flange 132b. The slot 135 can be tapered. The slot 135 can be tapered from an upper end of the slot to a lower end of the slot, either outwardly or inwardly. In the illustrated arrangement, the front and rear upper flanges 132a, 132b are angled towards each other. In other words, upper ends of the front and rear upper flanges 132a, 132b are closer to each other than lower ends of the front and rear upper flanges 132a, 132b.

The flute plug assembly 130 can include a fire blocking material 134. The fire blocking material 134 a mineral wool, fiberglass, compressible intumescent foam, backer rod, or other types of compressible or expanding fire-resistant material. The mineral wool can be stone mineral wool or glass mineral wool, such as that manufactured by ROXUL® Inc., THERMAFIBER® Inc., or any other manufacturer of suitable mineral wool., or other suitable fire block material known in the industry. The fire blocking material 134 can be located within the slot 135. The fire blocking material 134 can be at least somewhat compressed to fit within the slot 135. In some configurations, the fire blocking material 134 can be significantly compressed to fit within the slot 135, i.e., reduced at least about 25% or 30% from an original dimension. In an unassembled state, the fire blocking material 134 can be thicker than a depth of the slot 135 (e.g., at one or more points between the front and rear upper flanges 132a, 132b). The front and rear upper flanges 132a, 132b can be biased inwardly to secure the fire blocking material 134 within the slot 135. The fire blocking material 134 can be abutted against the front upper flange 132a, the rear upper flange 132b, the intermediate flange 141a, and/or the second intermediate flange 141b.

In certain implementations, the flute plug assembly 130 can include a fastener (e.g., screw, nail, clip or other) to secure the fire blocking material 134 within the slot 135. The fastener (not shown) can extend through one or more of the front upper flange 132a, the rear upper flange 132b and/or the fire blocking material 134. The fire block material 134 can be pre-assembled with the profile 131.

The fire blocking material 134 can define an outer profile. The outer profile can include a top 134a. The top 134a can be generally straight and/or include one or more cutout regions or curves. The outer profile can further include a first side 134b and/or a second side 134c. The first and second sides 134b, 134c can connect on opposite ends of the top 134a. In some implementations, the outer profile of the fire blocking material 134 can generally match the outer profile of the front upper flange 132a, the rear upper flange 132b, and/or the concave perimeter 123. The outer profile of the fire blocking material 134 can be generally trapezoidal.

An offset or spacing 150 can be defined between the outer profile of the fire blocking material 134 and the outer profile of the front upper flange 132a (or rear upper flange 132b). In one implementation, the spacing 150 can be uniform across the outer profiles (e.g., between any or all of the respective top, first, and/or second sides of each of the outer profiles). In another implementation, the spacing 150 can vary between any or all of the respective top, first, and/or second sides of each of the outer profiles. The spacing 150 can vary between an installed configuration, where the flute plug assembly is assembled within the flute void 122, and an uninstalled configuration. The spacing 150 can be less in the installed configuration than the uninstalled configuration due to compression. In one implementation, the spacing 150 can be between 0.25 inches and 0.75 inches in either the installed or uninstalled configurations. In other implementations, the spacing 150 can be less or greater than this given range.

The fire blocking material 134 can have a height 161. The height 161 can extend from the top surface 134a to a bottom surface thereof (e.g., at the intermediate flanges 141a, b). The height 161 can generally be between approximately 1.0 inches and 10.0 inches. In other implementations, the height 161 can be greater or less than this range. The front upper flange 132a (and/or rear upper flange 132b) can have a height 162. The height 162 can extend from the top surface 133a to the intermediate flanges 141a (and/or 141b). The height 162 can generally be between approximately 1.0 inches and 10.0 inches. In other implementations, the height 162 can be greater or less than this range. The height 162 can be less than the height 161. The lower flange 136 can have a height 163. The height 163 can extend from the intermediate flange 141a and/or 141b to a lowermost point of the lower flange 136. The height 163 can generally be between approximately 0.5 inches and 6.0 inches. In other implementations, the height 163 can be greater or less than this range. The intermediate flange 141a (and/or 141b) can have a length 164. The length 164 can extend from the lower flange 136 to the front upper flange 132a (or conversely the rear upper flange 132b). The length 164 can generally be between approximately 0.25 inches and 2.0 inches. In other implementations, the length 164 can be greater or less than this range.

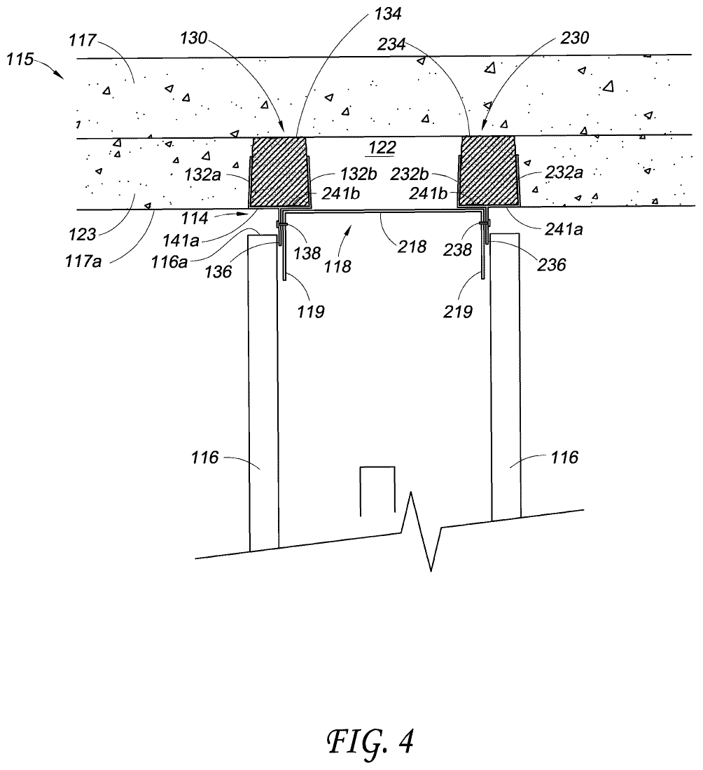

As shown in FIG. 4, the head-of-wall assembly 115 can further include one or more wallboards 116 (e.g., gypsum board or “drywall”). The wallboard 116 can be coupled to the plurality of studs 121. The header track 118 can include a web 218 and first and/or second legs 119, 219. The web 218 can connect the first and second legs 119, 219. The first leg 119 can couple with the web 218 at an orthogonal angle. The second leg 219 can couple with the web 218 at an orthogonal angle. An upper end of each of the plurality of studs 121 can fit between the first and second legs 119, 219. The studs 121 can be coupled to the first and/or second legs 119, 219 through a slot . The connection of the studs 121 with the sides 119/219 can allow motion of the wall relative to the ceiling 117.

The header wall assembly 115 can include a deflection gap 114. The deflection gap 114 can extend between the wallboards 116 and the ceiling 117. For portions of the head-of-wall assembly 115 not aligned with the flute void 122, the deflection gap 114 can extend between an upper surface 116a of each of the wallboards and the lowermost portion 117a of the ceiling 117. In portions of the head-of-wall assembly 115 that are aligned with the flute void 122, the head-of-wall assembly 115 can include the flute plug assembly 130. The flute plug assembly 130 can at least partially bound the deflection gap 114 across the flute void 122, as describe further below.

The flute plug assembly 130 can be coupled to the header track 118. The lower flange 136 can be coupled to the first leg 119 of the header track 118. The lower flange 136 can alternatively attach with the wallboard 116, the web 218 or another structure in the head-of-wall assembly 115. The lower flange 136 can attach with the header track 118 by one or more mechanical fasteners 138 (e.g. screw, clip, adhesive or similar). The lower flange 136 can include a slot or aperture for coupling with the header track 118 using the fastener 138.

The lower flange 136 can be positioned between the first leg 119 and the wallboard 116. The lower flange 136 can overlap with and/or be in contact with the first leg 119. The second intermediate flange 141b can overlap with and/or be in contact with the web 218 of the header track 118. In some implementations the second intermediate flange 141b can couple with the header track 118 by one or more fasteners, adhesives or other attachment mechanisms.

In some implementations, the intermediate flange 141a can be aligned with the web 218 of the header track 118 and/or the lowermost portion 117a of the ceiling 117. In portions of the head-of-wall assembly 115 aligned with the flute void 122, the deflection gap 114 can be defined between the upper surface 116a of the wallboard 116 and the intermediate flange 141a of the flute plug assembly 130. In some implementations, the intermediate flange 141a can extend across the flute void 122 (e.g., from the first side 123b to the second side 123c). Thus, in some implementations, the intermediate flange 141a can fully bound the deflection gap 114 between the upper and lower surfaces. In other implementations, the intermediate flange 141a can extend less or more than across the flute void 122. The intermediate flange 141a can provide a continuous or semi-continuous upper surface for the deflection gap 114 along a length of the header track 118. The intermediate flange 141a can allow for the use of advanced head-of-wall fire block arrangements to seal the head-of-wall assembly 115.

The flute plug assembly 130 can be installed within the flute void 122. At least a portion of the flute plug assembly 130 can extend a length into flute void 122. The fire blocking material 134 can be oversized relative to the concave perimeter 123 of the flute void 122. Installation of the flute plug assembly 130 within the flute void 122 and/or attachment with the header track 118 can engage and/or compress the fire blocking material 134 against the concave perimeter 123 of the flute void 122. In some implementations, the tops 123a/134a, first sides 123b/134b, and/or the second sides 123c/134c can be generally aligned. Engagement of the fire blocking material 134 can seal across the flute void 122.

The front and/or rear upper flanges 132a, 132b can at least partially maintain the shape of the fire blocking material 134. In some implementations, the tops 123a/134a/133a, first sides 123b/134b/133b, and/or the second sides 123c/134c/133c can be generally aligned. The front and/or rear upper flanges 132a, 132b can thus increase a compression force between the fire blocking material 134 and the concave perimeter 123 to improve the seal. Moreover, the front and/or rear upper flanges 132a, 132b can reduce the amount of fire blocking material 134 required to effectively seal the flute void 122 by providing an additional stiffness thereto.

In some implementations, the head-of-wall assembly 115 includes a single fluted plug assembly 130 installed on one side of the head-of-wall assembly 115. This can be adequate for certain situations. In other implementations, a second fluted plug assembly 230 can be included an opposite side of the head-of-wall assembly 115.

The second fluted plug assembly 230 can have a similar or identical structure as the fluted plug assembly 130. The second fluted plug assembly 230 can include a profile 231. The profile 231 can include a lower flange 236, an intermediate flange 241a, a second intermediate flange 241b, a front flange 232a, and/or a rear flange 232b. The fluted plug assembly 230 can further include a fire blocking material 234. The fire blocking material 234 can fit within a slot 235 between the front and rear flanges 232a, 232b. The fire blocking material 234 can be oversized relative to the concave perimeter 123 of the flute void 122. Thus, as the second fluted plug assembly 230 is fit within the fluted void 122, the fire blocking material 234 can compress to provide a seal across the flute void 122. The second flute plug assembly 230 can be attached to the header track 118. The lower flange 236 can be attached to the second leg 219 and/or the web 218 or other component of the head-of-wall assembly 115 by a fastener 238.

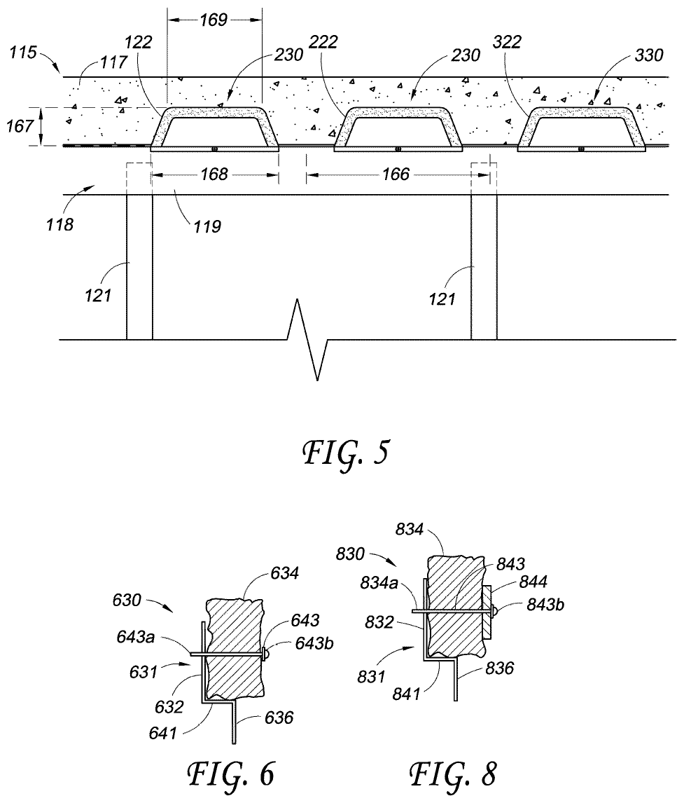

As shown in FIG. 5, in some implementations, the head-of-wall assembly 115 can include a multiple fluted plug assemblies along a length of the wall. The head of wall assembly 115 can include the second fluted plug assembly 230 within a second flute void 222. The head of wall assembly 115 can include a third fluted plug assembly 330 for sealing a third flute void 322. The fluted plug assembly 330 can be identical or similar to the fluted plug assemblies 130, 230. In an exemplary embodiment, the ceiling 117 can have a pitch 166 of between about 4.0 inches and 8.0 inches. In an exemplary embodiment, the flute void 122 can a depth 167 of between about 1.0 inches and 4.0 inches. In an exemplary embodiment, the flute void 122 can a base width 168 of between about 4.0 inches and 8.0 inches. In an exemplary embodiment, the flute void 122 can a top width 169 of between about 3.0 inches and 7.0 inches. In some configurations, the base width 168 of the flute plug 130 is less than the pitch 166 (e.g., sum of a maximum width of the flute and a distance between flutes). In some configurations, the base width 168 of the flute plug 130 is substantially equal to a maximum width of the flute void 122.

FIG. 6 shows another embodiment of a flute plug assembly 630. The flute plug assembly 630 can be structurally and functionally similar to the flute plug assembly 130, with differences as noted herein. The flute plug assembly 630 can include a profile 631. The profile 631 can be a sheet of bent metal, such as steel, aluminum or similar. The profile 631 can include a plurality of portion or flanges. The flanges can be generally planar and/or connected by bends in the profile. The profile 631 can include a lower flange 636. The lower flange 636 can be generally vertical. The lower flange 636 can be coupled to an intermediate flange 641. The intermediate flange 641 can be generally horizontal. The intermediate flange 641 can be coupled to an upper flange 632. The upper flange 632 can extend generally vertical.

The profile 631 can be coupled to a fire blocking material 634. The fire blocking material 634 can couple with the upper flange 632. The fire blocking material 634 can be in contact with the upper flange 632 and/or the intermediate flange 641. The flute plug assembly 630 can include a fastener 643. The fastener 643 can attach the fire blocking material 634 with the profile 631. In one implementation, the fastener 643 can be a mechanical fastener, such as a bolt. The fastener 643 can extend through a portion of the fire blocking material 634. An end 643a of the fastener 643 can engage within the upper flange 632. In one implementation, the end 643a extends into the upper flange 632 or another portion of the flute plug assembly 630. A head 643b of the fastener can engage with the fire blocking material 634.

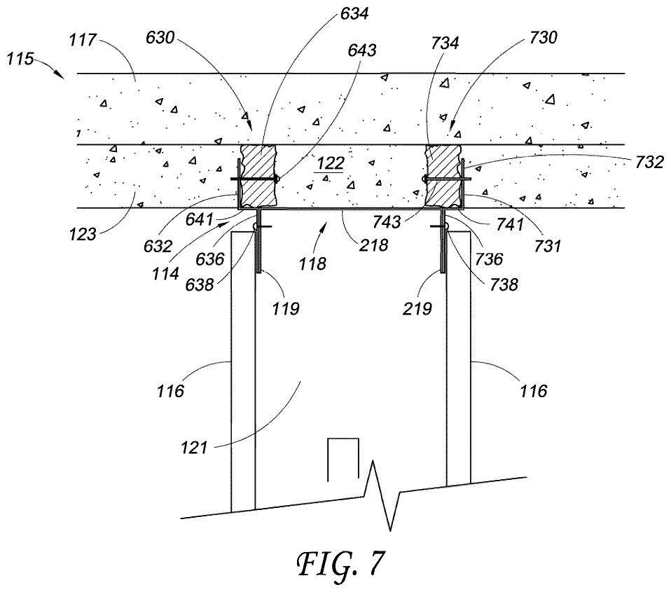

FIG. 7 illustrates the flute plug assembly 630 installed within the head-of-wall assembly 115. The lower flange 636 can be coupled to the header track 118. The lower flange 636 can be coupled to the header track 118 by a fastener 638. The lower flange 636 can be attached to the first leg 119 and/or the upper web 218. The lower flange 636 can be aligned with the first leg 119. The lower flange 636 can be located between the wallboard 116 and the first leg 119. The intermediate flange 641 can be aligned with the lower most surface 117a of the ceiling 117 and/or the web 218. The intermediate flange 641 can provide a continuous or semi-continuous upper surface across the deflection gap 114.

Similar to the installation of the fluted plug assembly 130, the fire blocking material 634 can be installed within the flute void 122. The fire blocking material 634 can be held in place by the profile 631. In one implementation, the upper flange 632 can face outwardly to the flute void 122. The fire blocking material 634 can be on an inward side of the flute void 122. Alternatively, the upper flange 632 and the fire blocking material 634 orientations can be reversed. The outer profile of the fire blocking material 634 can be compressed against the concave perimeter 123 of the flute void 122. This engagement can provide a seal across the flute void 122. In one implementation, the fire blocking material 634 can overlap and/or contact the web 218. The engagement of the fire blocking material 634 with the web 218 can position the flute plug assembly 630 with the header track 118.

In some implementations, the head-of-wall assembly 115 can further include a second fluted plug 730. The second flute plug assembly 730 can have the same or identical structure as the flute plug 630. The second flute plug 730 can include a fire blocking material 734, a fastener 743, a profile 731, an upper flange 732, an intermediate flange 741 and/or a lower flange 736. The second fluted plug 730 can be installed within a flute void 122. The fire blocking material 734 can face inwardly relative to the interior of the flute void 122. The lower flange 736 can couple with the header track 118, such as at the second leg 219 by a fastener 738.

FIG. 8 shows another embodiment of a flute plug assembly 830. The flute plug assembly 830 can be structurally similar to the flute plug assembly 630, with differences as noted herein. The flute plug assembly 830 can include a profile 831. The profile 831 can be a sheet of bent metal, such as steel, aluminum or similar. The profile 831 can include a plurality of portion or flanges. The flanges can be generally planar and/or connected by bends in the profile. The profile 831 can include a lower flange 836. The lower flange 836 can be generally vertical. The lower flange 836 can be coupled to an intermediate flange 841. The intermediate flange 841 can be generally horizontal. The intermediate flange 841 can be coupled to an upper flange 832. The upper flange 832 can extend generally vertical.

The profile 831 can be coupled to a fire blocking material 834. The fire blocking material 834 can couple with the upper flange 832. The fire blocking material 834 can be in contact with the upper flange 832 and/or the intermediate flange 841. The flute plug assembly 830 can include a fastener 843. The flute plug assembly 830 can include retainer or load-spreading element, such as a washer 844. The washer 844 can be a conventionally shaped washer or planar sheet having a hole therein for receiving the fastener 843. The fastener 843 can attach the washer 844 with the fire blocking material 834 and the profile 831. In one implementation, the fastener 843 can be a mechanical fastener such as a screw, bolt, clip, or similar. The fastener 843 can extend through a portion of the fire blocking material 834. An end 843a of the fastener 843 can engage within the profile 831. The second end 843b can engage with the washer 844 to distribute a retention force more evenly across or over a larger area of the fire blocking material 834 than without the washer 844.

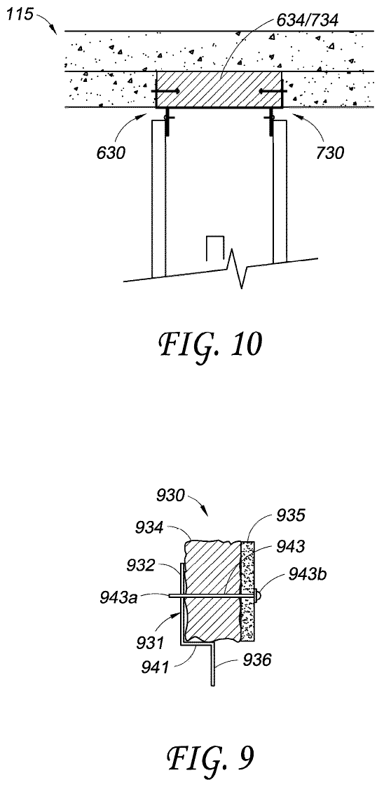

FIG. 9 illustrates another embodiment of a flute plug assembly 930. The flute plug assembly 930 can be similar or identical to the flute plug assembly 630, except as noted herein. The flute plug assembly 930 can include a profile 931. The profile 931 can be identical to the profile 631. The profile 931 can include a lower flange 936, an intermediate flange 941, and/or an upper flange 932. The flute plug assembly 930 can include a fire blocking material 934. The flute plug assembly 930 can include a fastener 943, such as a bolt. The fastener can include an end 943a and a head 943b. The fastener 943 can attach with a back stop 935. The back stop 935 can be a generally planar material, which can be separate from the profile 931. The back stop 935 can in some implementations be a piece of gypsum wallboard, wood, plastic or metal. The back stop 935 can be shaped to have an outer profile identical or similar to that of the fire blocking material 934 and/or the upper flange 932. The back stop 935 can include an aperture through which the fastener 943 extends. The back stop 935 can increase the surface area across which a retention force is applied by the fastener 943 to the fire blocking material 934. Accordingly, the back stop 935 can help preserve the shape of the fire blocking material 934 and/or can have the effect of increasing the compression force between the fire blocking material 934 and the outer concave perimeter 123 of the flute void 122.

FIG. 10 shows an expanded state of the fire blocking material 634 and/or 734. In some implementations, the fire blocking materials 634 and/or 734 can be formed of an intumescent material. The intumescent material expands when heated to a threshold temperature. When exposed to the heat of a fire the fire blocking material 634/734 can expand into the inner portion of the flute void 122. The expanded fire blocking material 634/634 can thus enhance the seal across the head-of-wall assembly 115.

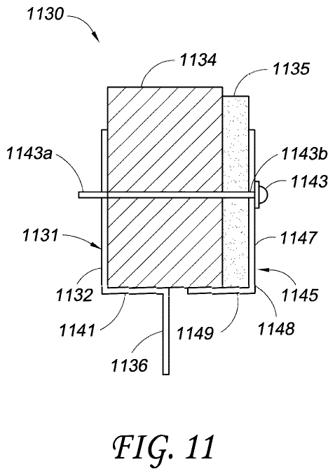

FIG. 11 illustrates another embodiment of a flute plug assembly 1130. The flute plug assembly 1130 can be similar or identical to the previous flute plug assemblies, except as noted herein. The flute plug assembly 1130 can include a profile 1131. The profile 1131 can be identical to the profile 631. The profile 1131 can include a lower flange 1136, an intermediate flange 1141, and/or an upper flange 1132. The flute plug assembly 1130 can include a fire blocking material 1134. The flute plug assembly 1130 can include a fastener 1143, such as a bolt. The fastener can include an end 1143a and a head 1143b. In some implementations, the fastener 1143 can attach with an optional back stop 1135. The back stop 1135 can be a generally planar material. The back stop 1135 can in some implementations be a piece of gypsum wallboard, wood, plastic or metal. The back stop 1135 can be shaped to have an outer profile identical or similar to that of the fire blocking material 1134 and/or the upper flange 1132. The back stop 1135 can include an aperture through which the fastener end 1143a extends. The fastener head 1143b can engage the back stop 1135. The back stop 1135 can increase the surface area for a retention force that is applied by the fastener 1143 to the fire blocking material 1134. Accordingly, the back stop 1135 can help preserve the shape of the fire blocking material 1134 and/or can have the effect of increasing the compression force between the fire blocking material 1134 and the outer concave perimeter 123 of the flute void 122.

The flute plug assembly 1130 can further include an angle 1145. The angle 1145 can be an angled sheet. The sheet can be metal such as steel, aluminum or other material. The angle 1145 can include a first leg 1147 and a second leg 1149. The second leg 1149 can attach with the first leg 1147, optionally at a bend 1148. The bend 1148 can form an angle between the first and second legs 1147, 1149. In some implementations, the angle 1145 can be approximately 90 degrees, although this is not required.

The angle 1145 can include an aperture though which the fastener end 1143a extends. The fastener head 1143b can engage the angle 1145. The first leg 1147 can overlap the back stop 1135 on one end thereof and/or the fire blocking material 1134 on one end thereof. The second leg 1149 can overlap the back stop 1135 on another end thereof. The angle 1145 can provide additional structural integrity to the shapes of the fire blocking material 1134 and/or the back stop 1135. The reinforced shape of the fire blocking material 1134 can provide additional stiffness to the fire block material 1134 which can increase the compression force between the concave perimeter 123 of the flute void 122 and the fire block material 1134 to improve the seal.

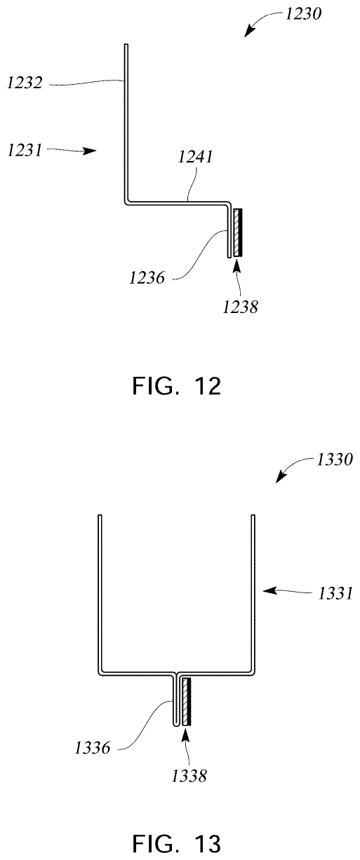

FIG. 12 is a section view of a profile 1231 that can be used to create another embodiment of a flute plug assembly 1230. The flute plug assembly 1230 can be structurally and functionally similar to the flute plug assembly 130, but can have differences as noted herein. The flute plug assembly 1230 can include any components, features, and/or other details of other flute plug assemblies disclosed herein whether or not such components, features, and/or details are explicitly identified. The flute plug assembly 1230 can include the profile 1231. The profile 1231 can be created from a sheet of bent metal, such as steel, aluminum or similar. The profile 1231 can include a plurality of portions or flanges. The flanges can be generally planar and/or connected by bends in the profile 1231. The profile 1231 can include a lower flange 1236. The lower flange 1236 can be generally vertical in an in-use orientation. The lower flange 1236 can be coupled to an intermediate flange 1241. The intermediate flange 1241 can be generally horizontal in the in-use orientation. The intermediate flange 1241 can be coupled to an upper flange 1232. The upper flange 1232 can extend generally vertical in the in-use orientation. The upper flange 1232 is offset from the lower flange 1236. In the illustrated arrangement, the upper flange 1232 and the lower flange 1236 extend from opposite edges of the intermediate flange 1241. The profile 1231 can be coupled to a fire blocking material (not shown in FIG. 12 for illustration purposes), which can be the same as or similar to fire blocking material 134 and/or fire blocking material 634 discussed earlier.

The flute plug assembly 1230 can include a fastener 1238. The fastener 1238 can be coupled to the lower flange 1236. In some embodiments, the fastener 1238 can be or include a strip of double-sided adhesive tape or a double-sided tape. In some embodiments, the double-sided tape 1238 can be factory-applied to the lower flange 1236. In some embodiments, the double-sided tape 1238 can include a thickness of about 2 mm or about 3 mm or about 4 mm or about 6 mm or other dimensions smaller than about 2 mm or larger than about 6 mm. The double-sided tape 1238 can have a width of about 3/8″, or about 1/2″, or larger than about 1/2″ wide or smaller than about 3/8″ wide. It some embodiments, the double-sided tape 1238 can be a double-sided foam tape (e.g., P4200 Series polyethylene foam tape from Pres-On Corporation of Bolingbrook, Illinois) or a double-sided adhesive film (e.g., tesa® 4965 Original from tesa tape, Inc. of Charlotte, North Carolina). The double-sided tape 1238 can include a release sheet that can be removed before the flute plug assembly 1230 is installed within a wall assembly. The double-sided tape 1238 can facilitate attachment of the flute plug assembly 1230 to a building component such as a header track. Although the fastener 1238 is illustrated as a double-sided tape in FIG. 12 (and similarly in FIGS. 13-16), other types of fasteners such as screws and/or other mechanical connectors can be used, in addition or in the alternative, in order to install the flute plug assembly 1230 within the wall assembly.

It has been unexpectedly discovered by the present inventor that using a double-sided tape 1238 in the flute plug assembly 1230 can have several advantages. For example, a double-sided tape 1238 in a single leg flute plug assembly (such as the flute plug assembly 1230 illustrated in FIG. 12) can create a thermal break between the flute plug assembly 1230 and the header track 119 so that the body of the flute plug assembly 1230 (which can include metal) does not directly contact the body of the header track (which can also include metal). This arrangement of using a double-sided tape 1238 to create a thermal break can eliminate a metal-to-metal connection that could rapidly transfer the heat to the flute plug assembly. Consequently, the amount of heat that can transfer between the flute plug assembly 1230 and the building component (such as the header track 119) can be reduced relative to a direct metal-to-metal connection or possibly minimized. Although the importance of such arrangement in a single leg flute plug assembly (such as the one shown in FIG. 12) may be signified, this arrangement can also contribute to fireproofing capabilities of other variations of the flute plug assembly (such as the double leg flute plug assembly 1330 illustrated in FIG. 13). As another example of the advantages of using a double-sided tape 1238 in the flute plug assembly 1230, the double-sided tape 1238 can eliminate the need for using other connectors which can be more time consuming (such as screw). This can make the process of installing the flute plug assembly 1230 within the wall assembly faster and easier. It is noted that a double-sided tape 1238 can be used in combination with all other embodiments of the present disclosure, including the embodiments of the flute plug assembly illustrated in FIGS. 1-11. However, in some embodiments, including the embodiments described below, the fastener 1238 (or fastener 1338) can be replaced with a thermal break component that doesn't secure, or doesn't secure on its own, the profile 1231 to the building component, such as the header track. For example, the fastener 1238 can be replaced by a strip of material capable of creating a thermal break (a “thermal break strip”), such as a non-metal material, a foam material (e.g., closed cell foam or semi-closed cell foam), a bead of fire-resistant sealant, a strip of PVC, or a strip of vinyl. Other suitable thermal break materials can also be used. In such arrangements, a separate fastener can be used to secure the profile 1231 to the building component, such as fastener 138 (see, e.g., FIG. 4).

FIG. 13 is a section view of a profile 1331 that can be used to create another embodiment of a flute plug assembly 1330. The flute plug assembly 1330 can include any of the components, features, and other details of the flute plug assemblies disclosed herein, including the flute plug assembly 130 and/or the flute plug assembly 1230. The flute plug assembly 1330 can include the profile 1331, which can include a double-wall lower flange 1336. In some embodiments, a fastener 1338 can be coupled to the lower flange 1336. In some embodiments, the fastener 1338 can be a double-sided tape. The fastener 1338 can include any components, features, and other details of the fastener 1238 discussed earlier. The fastener 1338 can facilitate the attachment of the flute plug assembly 1330 to an adjacent building component, such as a header track.

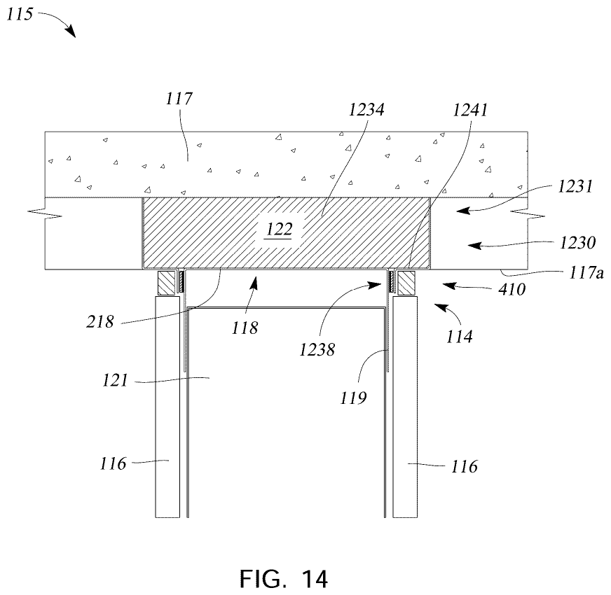

FIG. 14 is a section view of a head-of-wall assembly 115 incorporating a flute plug assembly 1230 having the profile 1231 of FIG. 12 on each side of the wall. In some embodiments, the flute plug assembly 1230 can include a fire blocking material 1234. In some embodiments, the fire blocking material 1234 can be coupled to the upper flange 1232 of one of the profiles 1231, if desired. The fire blocking material 1234 can be in contact with the upper flange 1232 and/or the intermediate flange 1241 of the profile 1231. In some embodiments, the fire blocking material 1234 can partially, substantially, or completely fill the flute void 122 between the profiles 1231. It is noted that the use of a single-leg flute plug assembly, such as the flute plug assembly 1230 illustrated in the head-of-wall assembly 115 of FIG. 14, can have several advantages. For example, in hospitals or other sensitive environments, small particles (e.g., infectious disease pathogens) can cling to any fibrous or open cell materials that are included in the fire blocking material 1234. This causes concern about a possible resulting spread of infectious diseases through the air plenum. Traditionally, a user would apply fireproofing spray over the fire blocking materials to address this concern. However, applying fireproofing spray can be messy and/or costly. The use of a single-leg flute plug assembly 1230 (such as the assembly illustrated in FIG. 14) can provide a similar (or better) benefit of concealing the fibrous materials of the fire blocking material, but without the extra cost and/or cleanup that would be required in the case of using a fireproofing spray.

Still referring to FIG. 14, the lower flange 1236 can be coupled to the header track 118. The lower flange 1236 can be coupled to the header track 118 by the fastener 1238, which, as discussed previously, can be a double-sided tape. The lower flange 1236 can be attached to the first leg 119. In some embodiments, the flute plug assembly 1230 can be positioned between the first leg 119 and a pre-formed firestop 410 or other suitable firestop. The pre-formed firestop 410 can be any suitable firestop that can provide the desirable fire-rating at the head-of-wall joint. Examples of pre-formed firestop products can include products marketed by the Applicant under the trade names CEMCO HOTROD® Type-X, CEMCO HOTROD® XL, or CEMCO Fire Gasket®. Other pre-formed firestopping products can also be used. The lower flange 1236 can be aligned with the first leg 119. In some embodiments, the lower flange 1236 can be located between the wallboard 116 and the first leg 119. The intermediate flange 1241 can be aligned with the lower most surface 117a of the ceiling 117 and/or the web 218. The intermediate flange 1241 can provide an upper surface across the deflection gap 114. The fire blocking material 1234 can be installed within the flute void 122 in a similar manner as the fluted plug assembly 130. The fire blocking material 1234 can be held in place by the profile 1231. The compression of the fire blocking material 1234 along with (or in addition to) profile 1231 (as secured by the fastener 1338) can hold the fire blocking material 1234 in place.

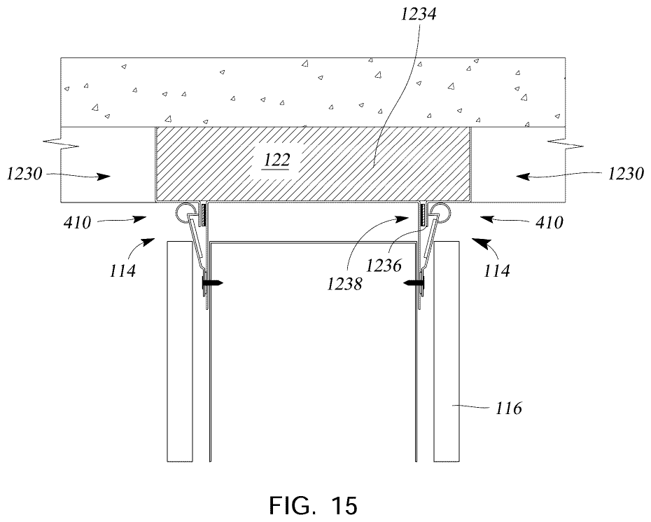

FIG. 15 is a section view of a head-of-wall assembly 115 incorporating the flute plug assembly 1230 of FIG. 12 and a pre-formed firestop 410 similar to CEMCO Fire Gasket®. In some implementations, the pre-formed firestop 410 can be positioned such that at least a portion of the pre-formed firestop 410 is between the wallboard 116 and the lower flange 1236.

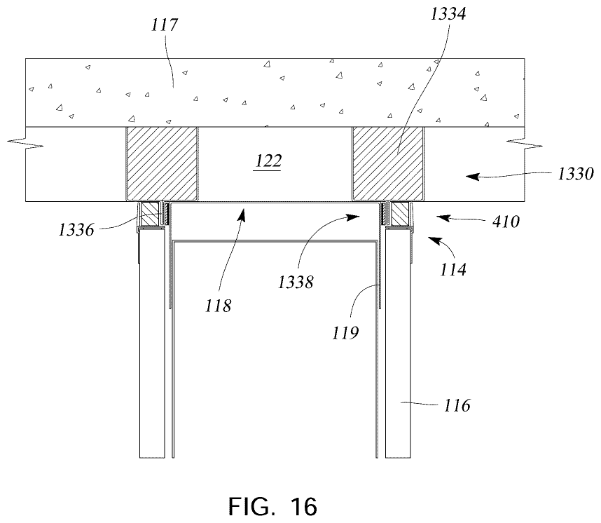

FIG. 16 is a section view of another head-of-wall assembly incorporating a flute plug assembly 1330 having the profile 1331 of FIG. 13 on each side of the wall and a pre-formed firestop 410 similar to CEMCO HOTROD® XL. The flute plug assembly 1330 can be coupled to the header track 118. The lower flange 1336 can be coupled to the first leg 119 of the header track 118. The lower flange 1336 can be positioned between at least a portion of the pre-formed firestop 410 and the first leg 119. The lower flange 1336 can attach to the header track 118 by a fastener 1338. In some embodiments, the fastener 1338 can be a double-sided tape as illustrated in FIG. 16. The flute plug assembly 1330 can be installed within the flute void 122. At least a portion of the flute plug assembly 1330 can extend a length into flute void 122. Installation of the flute plug assembly 1330 within the flute void 122 and/or attachment with the header track 118 can engage and/or compress the fire blocking material 1334 against the concave perimeter 123 of the flute void 122. Engagement of the fire blocking material 1334 can seal across or cover the flute void 122.

### Certain Terminology

Terms of orientation used herein, such as “top,” “bottom,” “proximal,” “distal,” “longitudinal,” “lateral,” and “end,” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a section region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately,” “about,” and “substantially,” mayrefer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

All ranges provided herein are inclusive of endpoints.

### SUMMARY

Several illustrative embodiments of head of wall assemblies have been disclosed. Although this disclosure has been described in terms of certain illustrative embodiments and uses, other embodiments and other uses, including embodiments and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various embodiments. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one embodiment or example in this disclosure can be combined or used with (or instead of) any other portion of any of the steps, processes, structures, and/or devices disclosed or illustrated in a different embodiment, flowchart, or example. The embodiments and examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative embodiments have been described, any embodiments having equivalent elements, modifications, omissions, and/or combinations are also within the scope of this disclosure. Moreover, although certain aspects, advantages, and novel features are described herein, not necessarily all such advantages may be achieved in accordance with any particular embodiment. For example, some embodiments within the scope of this disclosure achieve one advantage, or a group of advantages, as taught herein without necessarily achieving other advantages taught or suggested herein. Further, some embodiments may achieve different advantages than those taught or suggested herein.

Some embodiments have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular embodiment of the inventions disclosed herein. No aspects of this disclosure are essential or indispensable. In many embodiments, the devices, systems, and methods may be configured differently than illustrated in the figures or description herein. For example, various functionalities provided by the illustrated modules can be combined, rearranged, added, or deleted. In some embodiments, additional or different processors or modules may perform some or all of the functionalities described with reference to the example embodiment described and illustrated in the figures. Many implementation variations are possible. Any of the features, structures, steps, or processes disclosed in this specification can be included in any embodiment.

In summary, various embodiments and examples of head of wall assemblies and related methods have been disclosed. This disclosure extends beyond the specifically disclosed embodiments and examples to other alternative embodiments and/or other uses of the embodiments, as well as to certain modifications and equivalents thereof. Moreover, this disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims.

What is claimed is:

1. A head-of-wall assembly comprising:
a fluted pan deck comprising a plurality of flutes aligned along a first direction, a flute of the plurality of flutes defining a concave perimeter and a flute void;
a header track coupled to the fluted pan deck and aligned along a second direction, the second direction being transverse to the first direction, the header track comprising:
a first vertical leg;
a second vertical leg; and
a web coupling the first vertical leg and the second vertical leg;
a plurality of studs secured within the header track between the first vertical leg and the second vertical leg;
at least one wallboard coupled to the plurality of studs; and
a deflection gap across the head-of-wall assembly;
a first flute plug assembly comprising:
a profile comprising a vertical lower flange, the vertical lower flange coupled to an intermediate flange, the intermediate flange coupled to an upper flange having a first outer profile; and
a fire blocking material having a second outer profile;
a double-sided tape strip extending lengthwise along the vertical lower flange;
wherein the first flute plug assembly is aligned with the flute void and the vertical lower flange is coupled to the first vertical leg of the header track by the double-sided tape strip; and
wherein the fire blocking material compresses against the concave perimeter of the flute void to seal the head-of-wall assembly against fire, smoke and sound through the flute void and the upper flange assists in retaining the fire blocking material within the flute void.

2. The head-of-wall assembly of claim 1, wherein the profile is a sheet of bent steel.

3. The head-of-wall assembly of claim 1, wherein the first outer profile matches the concave perimeter of the flute void.

4. The head-of-wall assembly of claim 1, wherein the first outer profile is offset from the concave perimeter of the flute void at a spacing distance, the spacing distance being between 0.25 inches and 0.75 inches.

5. The head-of-wall assembly of claim 4, wherein the spacing distance is uniform across the first outer profile.

6. The head-of-wall assembly of claim 1, wherein the upper flange is biased inwardly to compress the fire blocking material.

7. The head-of-wall assembly of claim 1, wherein the intermediate flange is aligned with a lowermost portion of the fluted pan deck to provide an upper surface of the deflection gap across the flute void.

8. The head-of-wall assembly of claim 1, wherein the intermediate flange is aligned with the web of the header track and the vertical lower flange overlaps the first vertical leg of the header track.

9. The head-of-wall assembly of claim 1 wherein the concave perimeter and the first outer profile each include a top and first and second lateral sides.

10. The head-of-wall assembly of claim 1, further comprising:
a second flute plug assembly, the second flute plug assembly comprising:
a profile comprising a vertical lower flange, the vertical lower flange coupled to an intermediate flange, the intermediate flange coupled to an upper flange having a first outer profile; and
a fire blocking material;
wherein the first flute plug assembly is assembled on a first side of the flute void and the second flute plug assembly is assembled on a second side of the flute void, opposite the first side.

11. The head-of-wall assembly of claim 1, further comprising a second flute plug assembly, the first flute plug assembly is assembled on a first side of the flute void and the second flute plug assembly is assembled on a second side of the flute void, opposite the first side.

12. A head-of-wall assembly comprising:
a fluted pan deck comprising a plurality of flutes aligned along a first direction, a flute of the plurality of flutes defining a concave perimeter and a flute void;
a header track coupled to the fluted pan deck and aligned along a second direction, the second direction being transverse to the first direction, the header track comprising:
a first vertical leg;
a second vertical leg; and
a web extending between the first vertical leg and the second vertical leg and coupling the first vertical leg and the second vertical leg;
a plurality of studs positioned within and coupled to the header track;
at least one wallboard coupled to the plurality of studs; and
a flute plug assembly, comprising:
a pair of profiles each positioned on opposing sides of the header track, the pair of profiles each including a vertical lower flange, an intermediate flange, and a vertical upper flange, the vertical upper flanges each having a first outer profile, the flute plug assembly further comprising a fire blocking material having a second outer profile positioned between the vertical upper flanges;
wherein the flute plug assembly is coupled to the header track and aligned with the flute void such that the fire blocking material is disposed within the flute void, and the vertical lower flanges are aligned along and coupled to the first vertical leg and the second vertical leg of the header track with the double-sided tape; and
wherein the fire blocking material contacts the concave perimeter of the flute to seal the flute void against fire, smoke, and sound.

13. The head-of-wall assembly of claim 12, wherein the fire blocking material is compressible and the vertical upper flanges compress the fire blocking material against the concave perimeter.

14. The head-of-wall assembly of claim 12, wherein the second outer profile of the fire blocking material is larger in at least one direction than the concave perimeter of the flute void.

15. The head-of-wall assembly of claim 12, wherein the pair of profiles comprise a sheet of bent steel.

16. The head-of-wall assembly of claim 12, wherein the first outer profile is offset from the concave perimeter of the flute void at a spacing distance, the spacing distance being between 0.25 inches and 0.75 inches.

17. The head-of-wall assembly of claim 16, wherein the spacing distance is uniform across the first outer profile.

18. The head-of-wall assembly of claim 12, wherein the intermediate flanges are aligned with a lowermost portion of the fluted pan deck to provide an upper surface of a deflection gap across the flute void.

19. The head-of-wall assembly of claim 12, wherein the fire blocking material overlaps the web of the header track and the vertical lower flanges overlap a respective first leg or second leg of the header track.
